(19) United States
(12) Patent Application Publication
(10) Pub. No.: US 2023/0376963 A1
(43) Pub. Date: Nov. 23, 2023

(54) SYSTEMS AND METHODS FOR REVIEWING PAYMENTS USING ARTIFICIAL INTELLIGENCE

(71) Applicant: Change Healthcare Holdings, LLC, Nashville, TN (US)

(72) Inventors: Christopher Mayer, Johns Creek, GA (US); Balaji Lakshmi Ramakrishnan, Alpharetta, GA (US); Jessie Lilly, Augusta, ME (US); James McCarter Taylor, Roswell, GA (US); Miguel Moisés Serrano, Houston, TX (US); Sarah Paik, Chicago, IL (US); Loganandh Natarajan, Cumming, GA (US); Natalia Elizabeth Sturgill Lynch, Cartersville, GA (US)

(21) Appl. No.: 17/750,734

(22) Filed: May 23, 2022

(51) Int. Cl. G06Q 20/40; G06N 3/08

(52) U.S. Cl. CPC G06Q 20/4016; G06N 3/08

(57) ABSTRACT

In an embodiment, systems and methods for reviewing payments using artificial intelligence are provided. Training data is collected that includes payments made by insurance payors for claims received from medical providers. The payments may have been verified as correct and include metadata about the associated claim such as the medical service and whether the claim was in or out of network. The training data is used to train a model that predicts a payment amount for a claim from a medical provider for an insurance payor. When a payment is received, the model is used to predict the payment amount for the payment. The predicted amount is compared with the actual payment amount and is used to determine if the payment is anomalous. If the payment is anomalous, it is provided to an auditor who checks the payment for compliance with a contract between the payor and the provider.

### BACKGROUND

In healthcare, a medical claims clearing house may facilitate the tracking of claims made by medical providers to insurance payors, and payments made by insurance payors to the medical providers. Typically these payments are made in accordance with contracts between the medical providers and the insurance payors that specify how much a payor will pay for a variety of medical services provided by a medical provider.

One service provided by a medical claims clearing house is verifying that payments are being made for medical claims that is in accordance with a current contract between a payor and a medical provider. As may be appreciated, each medical provider and insurance payor may operate using a different contract, and the terms of each contract may change periodically. Accordingly, ensuring that payments are being made according to contract is difficult and time consuming.

One solution to the problem is the random auditing of payments. Generally, a payment from an insurance payor to a medical provider is randomly selected and sent to a human auditor. The auditor may then verify whether or not an amount of the payment is correct according to the contract between the payor and the provider. If the payment is not correct the insurance payor is notified that they are not complying with the contract. However, this method for checking compliance is not thorough, and does not consider risk or exposure when selecting payments to audit.

### SUMMARY

In an embodiment, systems and methods for reviewing payments using artificial intelligence are provided. Training data is collected that includes payments made by insurance payors for claims received from medical providers. The payments may have been verified as correct and may include metadata about the associated claim such as the associated medical service and whether the claim was in or out of network. The training data is used to train a model that predicts a payment amount for a claim from a medical provider for an insurance payor. When a payment is received, the model is used to predict the payment amount for the payment based on the metadata. The predicted amount is compared with the actual payment amount and is used to determine if the payment is anomalous. If the payment is anomalous, it is provided to an auditor who checks the payment for compliance with a contract between the payor and the provider.

The systems and methods described herein provide the following advantages. Because the model is used to check all payments, the risk of missing an incorrect payment is greatly reduced when compared with prior art methods. Because risk is also considered when determining whether or not to have auditors review anomalous payments, only payments that may have high associated costs due to contract non-compliance are reviewed, which leads to a lower need for costly human auditors.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate systems and methods for reviewing payments using artificial intelligence. Together with the description, the figures further serve to explain the principles of the systems and methods for reviewing payments using artificial intelligence described herein and thereby enable a person skilled in the pertinent art to make and use the systems and methods for reviewing payments using artificial intelligence.

FIG. 1 is an example environment for reviewing payments using artificial intelligence;

FIG. 2 is an illustration of an example method for training a payment model;

FIG. 3 is an illustration of an example method for determining anomalous payments using a payment model; and

FIG. 4′ shows an example computing environment in which example embodiments and aspects may be implemented.

### DETAILED DESCRIPTION

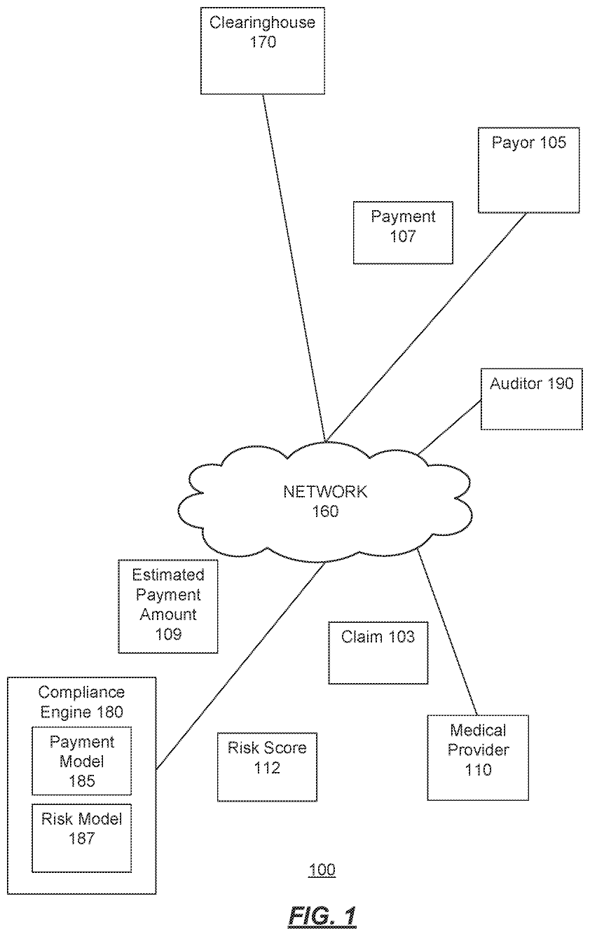

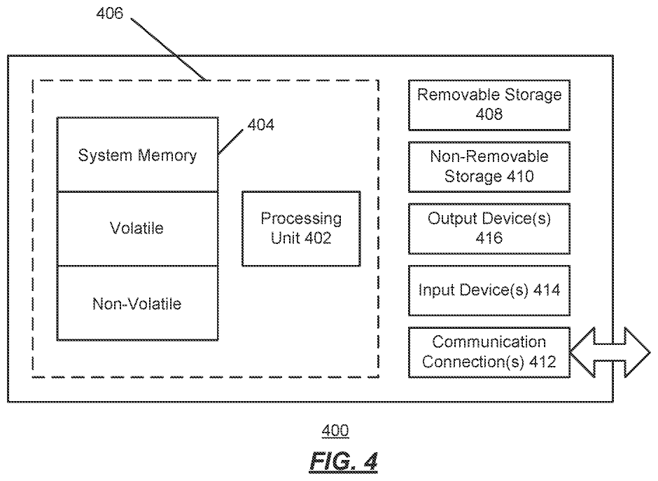

FIG. 1 is an example environment 100 for reviewing payments using artificial intelligence. As shown, the environment 100 may include a clearinghouse 170, one or more medical providers 110, one or more payors 105 and one or more auditors 190 in communication through a network 160. The network 160 may include a combination of private networks (e.g., LANs) and public networks (e.g., the Internet). Each of the clearinghouse 170, the medical provider 110, the auditor 190, and the payor 105 may use, or may be partially implemented by, one or more general purpose computing devices such as the computing device 400 illustrated in FIG. 4.

The clearinghouse 170 may be a medical claims clearinghouse 170 and may receive claims 103 for medical services rendered by medical providers 110 to patients 140. The clearinghouse 170 may then submit each received claim 103 to a c payor 105 (e.g., insurance company or government entity) that provides insurance coverage for the patient, and may receive information regarding payments 107 made by the payors 105 for the claims 103.

As described above, a payor 105 may submit a payment 107 for a claim 103 with a payment amount that is governed by a contract between the payor 105 and the medical provider 110. Each payor 105 and medical provider 110 pair may be subject to a different contract. Accordingly, it may be difficult for the clearinghouse 170 to determine if a payment 107 made by a payor 105 to a medical provider 110 was in compliance with the contract between the payor 105 and the provider 110.

To solve this problem, the environment 100 may further include a compliance engine 180 that determines an estimated payment amount 109 for a payment 107 between a payor 105 and a medical provider 110. If the estimated payment amount 109 is close to the actual payment amount of the payment 107, then the compliance engine 180 may take no action with respect to the payment 107. Else, the compliance engine 180 may send the payment 107 to one or more human auditors 190 for further review. The compliance engine 180 may be implemented using one or more general purpose computing devices such as the computing device 400 described with respect to FIG. 4.

The compliance engine 180 may determine an estimated payment amount 109 for a payment 107 using a payment model 185 and metadata associated with the payment 107. The metadata associated with a payment 107 may include a variety of information about the payment 107 and the claim 103 that the payment 107 is associated with. The metadata may include the medical procedure or service associated with the claims 103, whether the claim 103 was in or out of network, a location or region of the country where the medical procedure or service was provided, the payor 105 associated with the claim 103, and the medical provider 110 associated with the claim 103. Other information may be considered.

The payment model 185 may receive a payment 107, and based on the metadata associated with the payment 107, may generate an estimated payment amount 109. In addition, the compliance engine 180 may generate a confidence or probability that the estimated payment amount is 109 is correct.

In some embodiments, the payment model 185 may be an artificial intelligence based model, such as a neural network trained using machine learning. Other types of models may be used such as ARIMA or random forest decision tree based models.

The compliance engine 180 may train the payment model 185 using training data. The training data may include sets of payments 107 received from multiple payors 105 for multiple medical providers 110 for a variety of claims 103 for a variety of different medical procedures and medical services. Each payment 107 in the training data may have a payment amount that was verified to comply with a contract between the associated payor 105 and the associated medical provider 110. Depending on the embodiment, the payment amounts may have been verified by the one or more auditors 190. The auditors 190 may be human auditors trained to verify payment amounts using contracts.

In some embodiments, the compliance engine 180 may receive an indication of a payment 107 from a payor 105 to a medical provider 110. The compliance engine 180 may use the payment model 185 to generate an estimated payment amount 109. If the estimated payment amount 109 does not equal the actual payment amount associated with the payment 107, the compliance engine 180 may determine that the payment 107 is anomalous and may send it to an auditor 190 for review.

Alternatively, rather than send every anomalous payment 107 to an auditor 190 for review, the compliance engine 180 may calculate a risk score 112 for the anomalous payment 107. The risk score 112 may represent the risk of under or overpayment for the payor 105 and may be based on the difference between the estimated payment amount 109 and the actual payment amount of the payment 107. If the risk score 112 exceeds a threshold, then the compliance engine 180 may send the payment 107 to the auditor 190. Else, the compliance engine 180 may ignore the anomalous payment 107. The threshold risk score 112 may be set by a user or administrator.

In some embodiments, the risk score 112 for an anomalous payment 107 may be based on a variety of factors including the difference between the payment amounts, any penalties, fees. or fines associated with under or overpayment of a payment 107, and the confidence of the payment model 185 in the estimated payment amount 109. In addition, the compliance engine 180 may use a risk model 187 to generate the risk score 112. The risk model 187 may be trained using risk scores 112 previously generated for a set of anomalous payments 107.

When an anomalous payment 107 is sent to an auditor 190 by the compliance engine 180, the auditor 190 may use the contract associated with the payor 105 and the medical provider 110 of the payment 107 to determine what the correct payment amount should have been. Depending on the embodiment, the auditor 190 may determine the correct payment amount based on the contract and information about the payment 107 such as the associated medical procedure or service and whether or not the associated claim 103 was an in or out of network claim 103. Other information specified by the contract may be considered by the auditor 190.

After determining the correct payment amount for the payment 107, the auditor 190 may instruct the payor 105 so that the payment 107 can be corrected if necessary. The auditor 190 may include in the instruction a link to the contract that was used to generate the correct payment 107 so that the payor 105 can avoid the error in the future.

In some embodiments, the correct payment amount as determined by the auditor 190 may be used as feedback to train or update the payment model 185. Any method for retraining a model may be used.

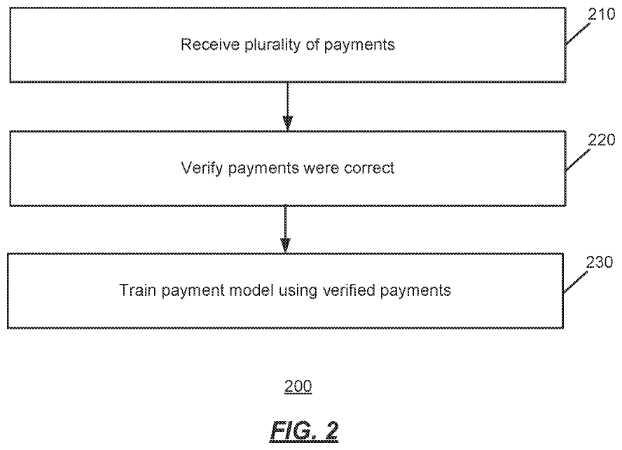

FIG. 2 is an illustration of an example method 200 for training a payment model. The method 200 may be implemented by the compliance engine 180.

At 210, a plurality of payments is received. The plurality of payment 107 may be received by the compliance engine 180 through the network 160. Depending on the embodiment, the payments 107 may be received by the compliance engine 180 from a claims clearinghouse 170. The payments 170 may be payments 170 that were received in the past by one or more medical providers 110 from one or more payors 105. Each payment 107 may be associated with metadata such as the name of the payor 105, the name of the provider 110, and the medical service or medical procedure associated with the claim 103 that the payment 107 is responsive to. Other information may be included.

At 220, that the payments were correct is verified. That the payment amount associated with each payment 107 was correct may be verified by one or more auditors 190. Each payment 107 of the plurality of payments 107 may be verified using a contract between the payor 105 and the medical provider 110 associated with the payment 107. The contract between a payor 105 and a medical provider may specify the payment amount for a variety of medical services and medical procedures that may be provided by the medical provider 110 to patients covered by the payor 105.

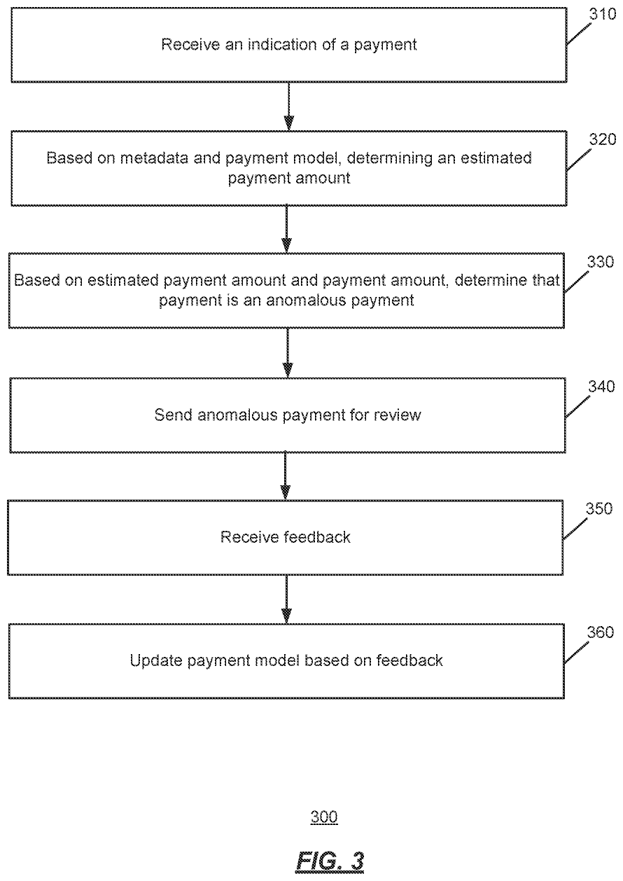

At 230, a payment model is trained using the verified payments. The compliance engine 180 may train the payment model 185 using the metadata and amounts of the received payments 107 that were verified correct by the auditors 190. In some embodiments, the payment model 185 may be an artificial intelligence model such as a neural network. Any method for training a model may be used. As will be discussed further with respect to the method 300 of FIG. 3, the payment model 185 may be used to estimate the payment amounts for subsequently received payments 107 from the payors 105.

FIG. 3 is an illustration of an example method 300 for determining anomalous payments using a payment model. The method 300 may be implemented by the compliance engine 180.

At 310, an indication of a payment is received. The indication of a payment 107 may be received by the compliance engine 180 from a claims clearinghouse 170. The payment 107 may have an associated amount and may be a payment between a payor 105 and a medical provider 110 for a medical procedure or medical service provided by the medical provider 110. The payment 107 may be associated with metadata that identifies the associated payor 105, provider 110, and one or more medical procedures or services associated with the claim 103 corresponding to the payment 107.

At 320, an estimated payment amount is determined. The estimated payment amount 109 may be determined by the compliance engine 180 using the payment model 185 and the metadata associated with the payment 107.

At 330, that the payment is an anomalous payment is determined. The payment 107 may be determined to be an anomalous payment 107 by the compliance engine 180 based on a difference between the actual payment amount of the payment amount 107 and the estimated payment amount 109. In general, the larger the difference between the estimated payment amount 109 and the actual payment amount of the payment 109, the more likely the compliance engine 180 is to determine that the payment 107 is anomalous. The threshold difference may be set by a user or administrator.

In some embodiments, the compliance engine 180 may determine that a payment 107 is an anomalous payment 107 by computing a risk score 112 for the payment 107, and determining if the risk score 112 exceeds a threshold. The risk score 112 may be based on the estimated payment amount 109 and the actual payment associated with the payment 107. Depending on the embodiment, the risk score 112 may be generated by the compliance engine 180 using a risk model 187.

At 340, the anomalous payment is sent for review. The anomalous payment 107 may be sent to an auditor 190 for review by the compliance engine 180. The auditor 190 may review the payment 107 using the contract between the payor 105 associated with the payment 107 and the medical provider 110 associated with the payment.

At 350, feedback is received. The feedback may be received by the compliance engine 180 from the auditor 190 through the network 160. The feedback may indicate the correct payment amount for the payment 107. The correct payment amount may be the same or different than either the amount associated with the payment 107 or the estimated payment amount 109.

At 360, the payment model is updated based on the feedback. The compliance engine 180 may use the feedback to update the payment model 185. Any method for updating or retraining a model may be used.

FIG. 4 shows an example computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an example system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although example implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving an indication of a payment from a payor to a provider by a computing device, wherein the payment is associated with metadata and a payment amount;
based on the metadata associated with the payment, determining an estimated payment amount for the payment by the computing device;
based on the estimated payment amount and the payment amount, determining that the payment is an anomalous payment by the computing device; and
in response to the determination, sending the payment for review by an auditor by the computing device.

2. The method of claim 1, wherein sending the payment for review by the auditor comprises sending the payment for review by the auditor for compliance with a contract between the payor and the provider.

3. The method of claim 1, wherein the payor is an insurance company.

4. The method of claim 1, wherein the provider is a medical provider.

5. The method of claim 1, wherein determining the estimated payment amount for the payment comprises determining the estimated payment amount using a payment model and the metadata associated with the payment.

6. The method of claim 5, further comprising:
receiving a plurality of previous payments and payment amounts; and
training the payment model using the plurality of previous payments.

7. The method of claim 5, wherein the payment model is a neural network.

8. The method of claim 5, further comprising:
receiving feedback from the auditor, wherein the feedback indicates a correct payment amount; and
updating the payment model using the received feedback.

9. The method of claim 1, wherein determining that the payment is an anomalous payment comprises calculating a risk score for the payment, and determining that the payment is an anomalous payment when the risk score satisfies a threshold.

10. The method of claim 9, wherein the risk score is based on a difference between the payment amount and the estimated payment amount.

11. A system comprising:
at least one processor; and
a computer-readable medium storing computer-executable instructions that when executed by the at least one processor cause the at least one processor to:
receive an indication of a payment from a payor to a provider, wherein the payment is associated with metadata and a payment amount;
based on the metadata associated with the payment, determine an estimated payment amount for the payment;
based on the estimated payment amount and the payment amount, determine that the payment is an anomalous payment; and
in response to the determination, send the payment for review by an auditor.

12. The system of claim 11, wherein sending the payment for review by the auditor comprises sending the payment for review by the auditor for compliance with a contract between the payor and the provider.

13. The system of claim 11, determining the estimated payment amount for the payment comprises determining the estimated payment amount using a payment model and the metadata associated with the payment.

14. The system of claim 13, further comprising:
receiving a plurality of previous payments and payment amounts; and
training the payment model using the plurality of previous payments.

15. The system of claim 13, wherein the payment model is a neural network.

16. The system of claim 13, further comprising:
receiving feedback from the auditor, wherein the feedback indicates a correct payment amount; and
updating the payment model using the received feedback.

17. The system of claim 11, wherein determining that the payment is an anomalous payment comprises calculating a risk score for the payment and determining that the payment is an anomalous payment when the risk score satisfies a threshold.

18. The system of claim 17, wherein the risk score is based on a difference between the payment amount and the estimated payment amount.

19. A computer-readable medium storing computer-executable instructions that when executed by the at least one processor cause the at least one processor to:
receive an indication of a payment from a payor to a provider, wherein the payment is associated with metadata and a payment amount;
based on the metadata associated with the payment and a payment model, determine an estimated payment amount for the payment;
based on the estimated payment amount and the payment amount, determine that the payment is an anomalous payment; and
in response to the determination, send the payment for review by an auditor.

20. The computer-readable medium of claim 19, further comprising:
receiving feedback from the auditor, wherein the feedback indicates a correct payment amount; and
updating the payment model using the received feedback.
